(19) United States
(12) Patent Application Publication
(10) Pub. No.: US 2005/0115807 A1
(43) Pub. Date: Jun. 2, 2005

(54) Vibratory conveyor apparatus

(75) Inventor: Gary Kostel, Latrobe, PA (US)

Correspondence Address: Henry C. Query, Jr., 504 S. Pierce Avenue, Wheaton, IL, 60187, US

(73) Assignee: FMC Technologies, Inc., Chicago, IL (US)

(21) Appl. No.: 10/943,707

(22) Filed: Sep. 17, 2004

Related U.S. Application Data
(60) Provisional application No. 60/503,657, filed on Sep. 17, 2003.

(51) Int. Cl. B65G 27/24

(52) U.S. Cl. 198/769

(57) ABSTRACT

A vibratory conveyor apparatus comprises a base, a conveyor trough which is movably supported by the base and an electromagnetic drive which includes at least one coil that is connected to the base and an armature that extends axially through the coil and is connected to the conveyor trough. Activation of the coil moves the armature axially in at least a first direction relative to the coil. Thus, the electromagnetic drive is operable to reciprocate the conveyor trough relative to the base.

This application is based on U.S. Provisional Patent Application No. 60/503,657, which was filed on Sep. 17, 2003.

### BACKGROUND OF THE INVENTION

The present invention relates generally to a vibratory conveyor apparatus which includes a conveyor trough that is movably supported relative to a base. More specifically, the invention relates to such an apparatus which comprises an electromagnetic drive for reciprocating the conveyor trough relative to the base.

Vibratory conveyors are widely used for a variety of material conveying applications. Such devices typically include a conveyor trough which is reciprocated by an associated vibratory drive to thereby induce motion in the material carried in the trough. Heretofore, vibratory drives have been either mechanical or electromagnetic in nature. Mechanical vibratory drives typically include a number of eccentrically mounted weights which when rotated induce vibratory motion in the conveyor trough. Electromagnetic vibratory drives usually comprise a magnet and coil assembly which when activated induces a vibratory motion in the conveyor trough.

### SUMMARY OF THE INVENTION

In accordance with the present invention, a vibratory conveyor apparatus is provided which comprises a base, a conveyor trough which is movably supported by the base, and an electromagnetic drive which includes at least one coil that is connected to the base and an armature that extends axially through the coil and is connected to the conveyor trough. Activation of the coil moves the armature axially in at least a first direction relative to the coil. Thus, the electromagnetic drive is operable to reciprocate the conveyor trough relative to the base.

In one embodiment of the invention, the conveyor apparatus also includes a mechanism for biasing the armature in at least a second direction which is opposite to the first direction. The biasing mechanism can be, for example, a spring member which is positioned against the armature. In addition, the force of the spring member against the armature is preferably adjustable.

In another embodiment of the invention, the electromagnetic drive comprises a least a second coil which when activated moves the armature in at least a second direction which is opposite to the first direction.

In yet another embodiment of the invention, activation of the coil alternately moves the armature axially in a first direction relative to the coil and in a second direction which is opposite to the first direction.

Thus, in contrast to prior art vibratory conveyor devices, the conveyor apparatus of the present invention is configured such that the armature of the electromagnetic drive is directly connected to the conveyor trough. The resulting construction of the conveyor apparatus is simple and economic to fabricate, can be readily configured into several embodiments, and can be used for a variety of material-handling applications.

Other features and advantages of the present invention will be made apparent from the following detailed description, with reference to the accompanying drawings.

### BRIEF DESCRIPTION OF THE DRAWINGS

FIG. 1 is a longitudinal cross sectional view of the vibratory conveyor apparatus of the present invention, with certain components shown schematically; and

FIG. 2 is an end elevation view of the vibratory conveyor apparatus illustrated in FIG. 1.

### DETAILED DESCRIPTION OF THE PREFERRED EMBODIMENTS

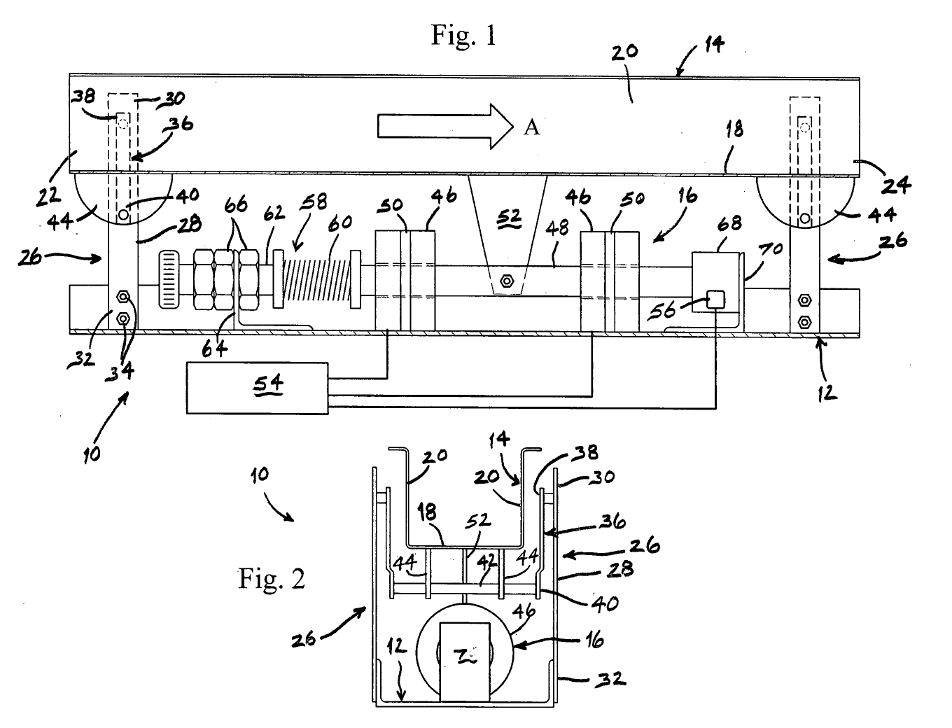

Referring to FIGS. 1 and 2, the vibratory conveyor apparatus of the present invention, which is indicated generally by reference number 10, includes a base 12, a conveyor trough 14 which is movably supported on the base, and an electromagnetic drive 16 for reciprocating the conveyor trough relative to the base. The base 12 can comprise any suitable support for the conveyor trough 14, such as an elongated member which comprises a channel-shaped cross section. In addition, the base 12 may be located in any desired position relative to the conveyor trough 14, such as above or, as shown in the Figures, below the conveyor trough.

The conveyor trough 14 can comprise any configuration which may be desired or required for a particular conveying application. In the illustrated embodiment of the invention, for example, the conveyor trough 14 comprises an elongated, generally flat conveying surface 18, two side walls 20 which extend generally upwardly from opposite sides of the conveying surface, an inlet end 22 which is located at one end of the conveying surface and a discharge end 24 which is located at a distal end of the conveying surface. Material to be conveyed by the conveyor apparatus 10 is deposited on the conveying surface 18 proximate the inlet end 22 and is transported longitudinally along the conveying surface to the discharge end 24.

The conveyor trough 14 is movably supported on the base 12 by a number of upstanding support members 26, four of which are employed in the embodiment of the invention illustrated in the drawings. Each support member 26 includes an elongated bracket 28 which comprises a first or upper end 30 that is ideally located proximate the conveyor trough 14 and a second or lower end 32 that is rigidly secured to the base, such as by a number of bolts 34. Each support member 26 also includes a suspension link 36 which is connected between the bracket 28 and the conveyor trough 14. For example, each suspension link 36 may comprise a first or upper end 38 that is pivotally connected to the first end 30 of the bracket 28 and a second or lower end 40 that is pivotally connected via a suitable pivot bar 42 to a corresponding trough bracket 44 which in turn is attached such as by welding to the bottom of the conveying surface 18. Thus, the support members 26 provide vertical support for the conveying trough 14 while permitting the conveying trough to reciprocate longitudinally relative to the base 12.

In accordance with the embodiment of the invention which is illustrated in the drawings, the electromagnetic drive 16 includes a number of electromagnetic coils 46 and an elongated armature 48 which extends axially through the coils. The coils 46 can comprise any conventional electromagnetic coil which is suitable for use in a linear electromagnetic drive. In addition, each coil 46 is preferably secured to the base 12 by suitable means, such as a corresponding radial clamp 50 which in turn is attached to the base by any known device.

The armature 48 can comprise any suitable device that is capable of producing a resultant force under the influence of the electric fields which are generated by the coils 46. As shown in the drawings, for example, the armature 48 can comprise an elongated rod which has a circular cross section and a uniform diameter from end to end. In addition, the armature 48 can be made from any of a variety of suitable electrically-conductive materials, such as ferrous materials, aluminum, and the like. Thus, when the coils 46 are activated, the armature 48 will be forced to move axially relative to the coils.

In accordance with the present invention, this axial motion of the armature 48 is transferred to the conveyor trough 14 to thereby transport the materials on the conveying surface 18 from the inlet end 22 to the discharge end 24. Accordingly, the conveying apparatus 10 also includes suitable means for transferring the motion of the armature 48 to the conveyor trough 14. For example, when as shown in the drawings the armature 48 is located below the conveyor trough 14, the conveying apparatus 10 may include a trough connector 52 which comprises an upper end that is attached such as by welding to the bottom of the conveying surface 18 and a lower end that may be either rigidly or pivotally connected to the armature 48. Moreover, the electromagnetic drive 16 is ideally positioned with the armature 48 in alignment with the conveyor trough 14 so that the reciprocating motion of the armature may be transferred directly to the conveyor trough through the trough connector 52.

The coils 46 can be activated in a variety of fashions to effect a desired reciprocating motion of the armature 48 and, thus, the conveyor trough 14. In addition, the activation of the coils 46 is preferably controlled via suitable electronic control unit 54. Furthermore, the conveyor apparatus 10 may include at least one operating switch 56 which is responsive to the position of the armature 48 to facilitate the activation of the coils 46 to effect the desired reciprocating motion of the armature. For example, the operating switch 56 may comprise a non-contact proximity switch which generates a signal when the armature 48 is at one end of its stroke. The operating switch 56 may alternatively comprise any of a variety of other switches, such as contact switches, optical switches, Hall-effect sensors, and the like.

In accordance with one embodiment of the invention, the coils 46 act in concert with each other and in opposition to a biasing mechanism 58. In the embodiment of the invention shown in the drawings, the biasing mechanism 58 includes a spring member 60 which is supported on the end of a threaded rod 62 that is connected to the base 12 via a suitable bracket 64. The biasing mechanism 58 is preferably designed so that the spring member 60 is positioned in axial alignment against an end of the armature 48. In addition, the threaded rod 62 is secured to the bracket 64 with a number of counteracting nuts 66. Thus, the pre-load force of the spring member 60 against the armature 48 can be selectively adjusted by changing the position of the threaded rod 62 relative to the bracket 64. In this manner, the stroke of the armature 48 may also be adjusted. Although the spring member 60 is illustrated in the drawings as a compression coil spring, other types of spring members can be employed in the biasing mechanism 58, including elastomeric spring elements. Additionally, the spring member 60 may be configured as a tension spring rather than a compression spring.

In the illustrated embodiment of the invention, the biasing mechanism 58 moves the armature 48 in the material-conveying direction, which is indicated by the arrow A in FIG. 1, while the coils 46 act together in opposition to the biasing mechanism to move the armature in the opposite, or return, direction. However, the conveyor apparatus 10 may be configured so that the coils 46 advance the armature 48 in the material-conveying direction, while the biasing mechanism 58 moves the armature in the return direction.

In an alternative embodiment of the invention, the coils 46 alone can be activated to reciprocate the armature 48. In this embodiment, one of the coils 46 is oriented to move the armature 48 in the material-conveying direction and the other coil is oriented to move the armature in the return direction. The armature 48 can then be reciprocated by alternately activating the coils 46. Alternatively, the conveyor apparatus 10 may employ one or more coils 46 which are capable of being reversibly activated. In this embodiment, the armature 48 may be reciprocated by merely reversing the polarity of the current which activates the coil 46.

The conveyor apparatus 10 may also include a bumper 68 for the armature 48. In the embodiment of the invention shown in FIG. 1, the bumper 68 is positioned at the end of the armature 48 opposite the biasing mechanism 58 and is connected to the base via a suitable bracket 70. The bumper 68 may thus be used to limit the stroke of the armature 48 in the material-conveying direction.

The conveyor apparatus 10 functions generally in the nature of known mechanically-driven vibratory conveyor devices. As is well understood by persons skilled in the art, these devices create differing acceleration forces during the material-conveying and return strokes to thereby advance the material along the conveyor trough 14. Generally, the conveyor trough 14 is accelerated more slowly in the material-conveying direction than in the return direction to incrementally and repeatedly advance the material along the conveying surface 18. While the specific operational parameters of the conveyor apparatus 10 will depend upon the specific dimensions of the apparatus and the particular conveying requirements, it is presently contemplated that the electromagnetic drive 16 may be operated to stroke the conveyor trough 14 from between about 0.1 inch to about 0.4 inch.

It should be recognized that, while the present invention has been described in relation to the preferred embodiments thereof, those skilled in the art may develop a wide variation of structural and operational details without departing from the principles of the invention. Therefore, the appended claims are to be construed to cover all equivalents falling within the true scope and spirit of the invention.

1. A vibratory conveyor apparatus which comprises:
a base;
a conveyor trough which is movably supported by the base;
an electromagnetic drive which includes at least one coil that is connected to one of the base and the conveyor trough and an armature that extends axially through the coil and is connected to the other of the base and the conveyor trough;
wherein activation of the coil moves the armature axially in at least a first direction relative to the coil;
whereby the electromagnetic drive is operable to reciprocate the conveyor trough relative to the base.

2. The vibratory conveyor apparatus of claim 1, wherein the coil is connected to the base and the armature is connected to the conveyor trough.

3. The vibratory conveyor apparatus of claim 1, further comprising means for biasing the armature in at least a second direction which is opposite to the first direction.

4. The vibratory conveyor apparatus of claim 3, wherein the biasing means comprises a spring member which is positioned against the armature.

5. The vibratory conveyor apparatus of claim 4, wherein the force of the spring member against the armature is adjustable.

6. The vibratory conveyor apparatus of claim 1, wherein the electromagnetic drive comprises at least two coils which when activated move the armature in a least the first direction.

7. The vibratory conveyor apparatus of claim 1, wherein the electromagnetic drive comprises a least a second coil which when activated moves the armature in at least a second direction which is opposite to the first direction.

8. The vibratory conveyor apparatus of claim 1, wherein activation of the coil alternately moves the armature axially in a first direction relative to the coil and in a second direction which is opposite to the first direction.

9. The vibratory conveyor apparatus of claim 1, further comprising an electronic control unit for controlling the activation of the coil.

10. The vibratory conveyor apparatus of claim 9, further comprising:
an operating switch which is responsive to the position of the armature;
wherein the electronic control circuit employs a signal from the operating switch to control the activation of the coil.

11. The vibratory conveyor apparatus of claim 1, further comprising a number of upstanding support members which each include:
an elongated bracket which comprises a first end that is located proximate the conveyor trough and a second end that is connected to the base; and
a suspension link which comprises a first end that is pivotally connected to the first end of the bracket and a second end that is pivotally connected to the conveyor trough.

12. A vibratory conveyor apparatus which comprises:
a base;
a conveyor trough which includes a conveying surface that is oriented generally parallel to the base;
means for movably supporting the conveyor trough on the base;
an electromagnetic drive which is oriented generally parallel to the base and includes at least one coil that is connected to the base and an armature that extends axially through the coil and is connected to the conveyor trough;
wherein activation of the coil moves the armature axially in at least a first direction relative to the coil;
whereby the electromagnetic drive is operable to reciprocate the conveyor trough relative to the base.

13. The vibratory conveyor apparatus of claim 12, further comprising means for biasing the armature in at least a second direction which is opposite to the first direction.

14. The vibratory conveyor apparatus of claim 13, wherein the biasing means comprises a spring member which is positioned against the armature.

15. The vibratory conveyor apparatus of claim 14, wherein the force of the spring member against the armature is adjustable.

16. The vibratory conveyor apparatus of claim 12, wherein the electromagnetic drive comprises at least two coils which when activated move the armature in a least the first direction.

17. The vibratory conveyor apparatus of claim 12, wherein the electromagnetic drive comprises a least a second coil which when activated moves the armature in at least a second direction which is opposite to the first direction.

18. The vibratory conveyor apparatus of claim 12, wherein activation of the coil alternately moves the armature axially in a first direction relative to the coil and in a second direction which is opposite to the first direction.

19. The vibratory conveyor apparatus of claim 12, further comprising:
an operating switch which is responsive to the position of the armature to generate a signal that is used to control the activation of the coil.

20. The vibratory conveyor apparatus of claim 12, wherein the support means comprises a number of upstanding support members which each include:
an elongated bracket which comprises a first end that is located proximate the conveyor trough and a second end that is connected to the base; and
a suspension link which comprises a first end that is pivotally connected to the first end of the bracket and a second end that is pivotally connected to the conveyor trough.
